(19) United States
(12) Patent Application Publication
(10) Pub. No.: US 2018/0032485 A1
(43) Pub. Date: Feb. 1, 2018

(54) IMAGE FORMING APPARATUS FOR DIGITIZING DOCUMENT BASED ON REVISED AND CORRECTED ORIGINAL DOCUMENT BY HAND WRITING, METHOD AND RECORDING MEDIUM

(71) Applicant: KYOCERA Document Solutions Inc., Osaka (JP)

(72) Inventor: Yosuke KASHIMOTO, Osaka (JP)

(73) Assignee: KYOCERA Document Solutions Inc., Osaka (JP)

(21) Appl. No.: 15/660,415

(22) Filed: Jul. 26, 2017

(30) Foreign Application Priority Data
Jul. 28, 2016 (JP) 2016-149069

(51) Int. Cl. G06F 17/21; H04N 1/00; G06K 9/00; G06F 17/24

(52) U.S. Cl. CPC G06F 17/218; G06F 17/241; H04N 1/00167; G06F 17/212; G06K 9/00449; G06K 9/00456

(57) ABSTRACT

An image forming apparatus includes a reading device, an image obtaining unit, a revised-portion extracting unit, a region extracting unit, a layout index determining unit, and an original document editing unit. The layout index determining unit determines an index of a layout of the initial original document based on the region extracted by the region extracting unit. The original document editing unit edits the initial original document with a correction content instructed with the revised portion extracted by the revised-portion extracting unit according to the index determined by the layout index determining unit, so as to generate a digitized document. The layout index determining unit determines a continuity between the regions of characters. The original document editing unit edits the initial original document as a continued plurality of the regions that are determined to have a continuity by the layout index determining unit.

### INCORPORATION BY REFERENCE

This application is based upon, and claims the benefit of priority from, corresponding Japanese Patent Application No. 2016-149069 filed in the Japan Patent Office on Jul. 28, 2016, the entire contents of which are incorporated herein by reference.

### BACKGROUND

Unless otherwise indicated herein, the description in this section is not prior art to the claims in this application and is not admitted to be prior art by inclusion in this section.

There is known a typical document editing device that digitizes a document based on a revised and corrected original document by hand writing. However, a character layout becomes unnatural in digitized documents by the typical document editing device.

### SUMMARY

An image forming apparatus according to one aspect of the disclosure includes a reading device, an image obtaining unit, a revised-portion extracting unit, a region extracting unit, a layout index determining unit, and an original document editing unit. The reading device reads an image from an original document. The image obtaining unit obtains an image of a revised and corrected original document corrected by hand writing using the reading device. The revised-portion extracting unit extracts a revised portion from the image of the revised and corrected original document obtained by the image obtaining unit. The region extracting unit extracts a region included in an initial original document of the revised and corrected original document from the initial original document. The layout index determining unit determines an index of a layout of the initial original document based on the region extracted by the region extracting unit. The original document editing unit edits the initial original document with a correction content instructed with the revised portion extracted by the revised-portion extracting unit according to the index determined by the layout index determining unit, so as to generate a digitized document. The layout index determining unit determines a continuity between the regions of characters. The original document editing unit edits the initial original document as a continued plurality of the regions that are determined to have a continuity by the layout index determining unit.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram of an MFP according to one embodiment of the disclosure;

FIG. 2 illustrates an operation of the MFP according to the one embodiment when a document is digitized based on a revised and corrected original document;

FIG. 3 illustrates an example of an image of the revised and corrected original document illustrated in FIG. 2;

FIG. 4 illustrates an image of a revised portion of the revised and corrected original document illustrated in FIG. 3;

FIG. 5 illustrates an image of an initial original document of the revised and corrected original document illustrated in FIG. 3;

FIG. 6 illustrates an image of the initial original document illustrated in FIG. 5 separated into a plurality of regions;

FIG. 7 illustrates an image of an initial original document separated into a plurality of regions and the image is an example different from the example illustrated in FIG. 6;

FIG. 8 illustrates a part of an image of an initial original document separated into a plurality of regions and the image is an example different from the examples illustrated in FIGS. 6 and 7;

FIG. 9 illustrates original document layout information generated from the image illustrated in FIG. 6;

FIG. 10 illustrates an editing process illustrated in FIG. 2;

FIG. 11 illustrates a part of the original document layout information illustrated in FIG. 9 when a character region is newly added;

FIG. 12A illustrates an example of a region when the MFP according to the one embodiment does not detect a “title”;

FIG. 12B illustrates an example of the region when the MFP according to the one embodiment detects the “title”;

FIG. 13 illustrates a digitized document based on the revised and corrected original document illustrated in FIG. 3;

FIG. 14 illustrates a layout for the document illustrated in FIG. 13;

FIG. 15 illustrates an example of an image of the revised and corrected original document but the example is different from the example illustrated in FIG. 2;

FIG. 16 illustrates an image of an initial original document of the revised and corrected original document illustrated in FIG. 15;

FIG. 17 illustrates an image of the initial original document illustrated in FIG. 16 separated into a plurality of regions;

FIG. 18 illustrates a digitized document based on the revised and corrected original document illustrated in FIG. 15; and

FIG. 19 illustrates a layout for the document illustrated in FIG. 18.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes one embodiment of the disclosure referring to the accompanying drawings.

First, a description will be given of a configuration of a Multifunction Peripheral (MFP) as an image forming apparatus according to the embodiment.

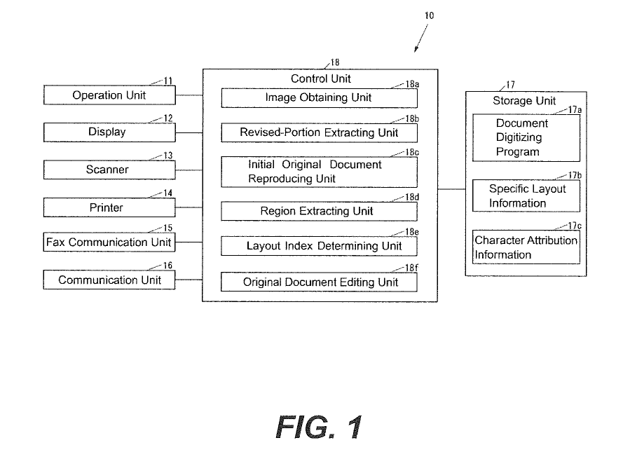

FIG. 1 illustrates a block diagram of an MFP 10.

As illustrated in FIG. 1, the MFP 10 includes an operation unit 11, a display 12, a scanner 13, a printer 14, a fax communication unit 15, a communication unit 16, a storage unit 17, and a control unit 18. The operation unit 11 is an operation device, such as a button with which various kinds of operations are input. The display 12 is a display device, such as a Liquid Crystal Display (LCD) that displays various kinds of information. The scanner 13 is a reading device that reads an image from an original document. The printer 14 is a print device that executes printing on a recording medium, such as a paper sheet. The fax communication unit 15 is a fax device that performs fax communication with an external facsimile device (not illustrated) via a communication line, such as a dial-up line. The communication unit 16 is a communication device that communicates with an external device directly by wired communication or wireless communication without a network, such as a Local Area Network (LAN) or the Internet, or via the network. The storage unit 17 is a non-volatile storage device, such as a semiconductor memory and a Hard Disk Drive (HDD), that stores various kinds of data. The control unit 18 controls the whole MFP 10.

The storage unit 17 stores a document digitizing program 17a for digitizing a document based on an original document that is corrected by hand writing (hereinafter referred to as a “revised and corrected original document”). The document digitizing program 17a may be installed in the MFP 10 at production stage of the MFP 10, may be additionally installed in the MFP 10 from a storage medium, such as an SD card and a Universal Serial Bus (USB) memory, or may be additionally installed in the MFP 10 from the network.

The storage unit 17 can store specific layout information 17b that indicates a specific layout, such as a layout regarding a header and footer and a layout regarding a column setting for a body text. The storage unit 17 may store the specific layout information 17b for each user of the MFP 10 or each group to which the user of the MFP 10 belongs. The MFP 10 is configured to generate the specific layout information 17b by preliminarily learning assumed original documents. For example, when a frequency of original document with double column setting is equal to or more than a certain frequency for a specific user, the MFP 10 can include a layout of double column setting for body text in this this user's specific layout information 17b.

The storage unit 17 can store character attribution information 17c that indicates an attribution, such as a character size, a font, a thickness, and a distance between characters. The character attribution information 17c may indicate an attribution of a character according to a position where the character is included, such as a header, a footer, and a body text. The storage unit 17 may store the character attribution information 17c for each user of the MFP 10 or each group to which the user of the MFP 10 belongs. The MFP 10 is configured to generate the character attribution information 17c by preliminarily learning assumed original documents.

The control unit 18 includes, for example, a Central Processing Unit (CPU), a Read Only Memory (ROM) that stores programs and various kinds of data, and a Random Access Memory (RAM) that is used for a work area of the CPU of the control unit 18. The CPU of the control unit 18 executes a program stored in the ROM of the control unit 18 or in the storage unit 17.

The control unit 18 ensures an image obtaining unit 18a, a revised-portion extracting unit 18b, an initial original document reproducing unit 18c, a region extracting unit 18d, a layout index determining unit 18e, and an original document editing unit 18f. The image obtaining unit 18a obtains an image of the revised and corrected original document with the scanner 13 by executing the document digitizing program 17a stored in the storage unit 17. The revised-portion extracting unit 18b extracts a portion with hand written correction instructions, that is, a revised portion from the image of the revised and corrected original document obtained by the image obtaining unit 18a. The initial original document reproducing unit 18c reproduces an original document before the hand written correction, that is, an initial original document from the image of the revised and corrected original document. The region extracting unit 18d extracts a region of a character region and a drawing region that is included in the initial original document from the initial original document. The layout index determining unit 18e determines a layout index of the initial original document based on the region extracted by the region extracting unit 18d. The original document editing unit 18f generates a digitized document by editing the initial original document of the revised and corrected original document with a correction content instructed by the revised portion extracted by the revised-portion extracting unit 18b.

Next, a description will be given of an operation of the MFP 10 when a document is digitized based on a revised and corrected original document.

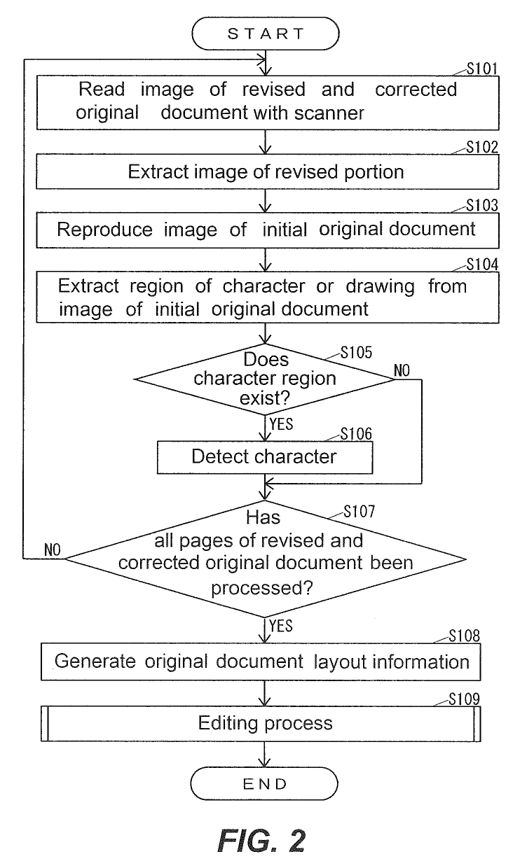

FIG. 2 illustrates an operation of the MFP 10 when a document is digitized based on a revised and corrected original document.

The control unit 18 executes the process illustrated in FIG. 2 when an instruction to digitize a document based on a revised and corrected original document is input via the operation unit 11.

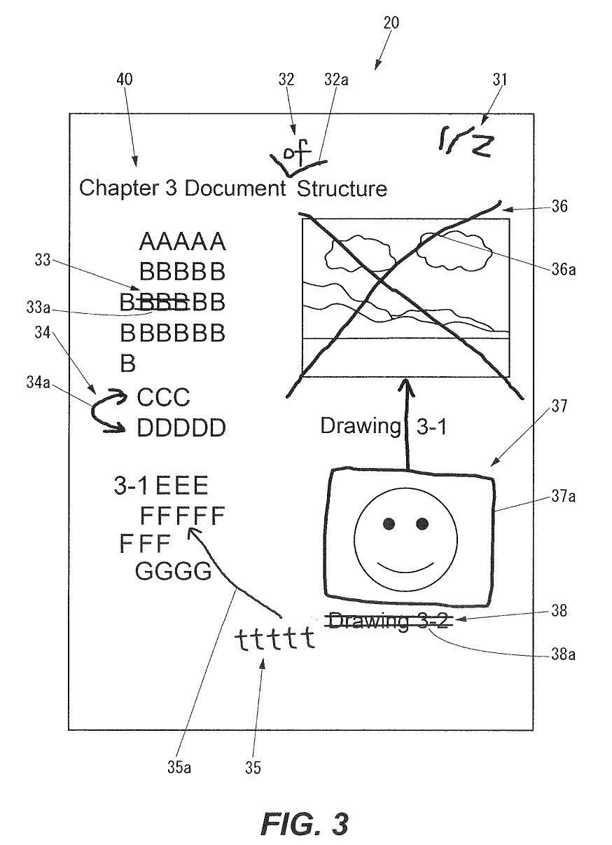

As illustrated in FIG. 2, the image obtaining unit 18a reads an image 20 (for example, see FIG. 3) with the scanner 13 from a revised and corrected original document set in the scanner 13 (Step S101).

FIG. 3 illustrates an example of the image 20 of the revised and corrected original document.

The image 20 illustrated in FIG. 3 is an image in which correction instructions 31 to 38 are added to an image 40 of an initial original document by hand writing with a writing material in a specific color, such as red.

The instruction 31 is an instruction to add characters “1/2” on the right edge in the header.

The instruction 32 is an instruction to add a character string “of” between a character string “document” and a character string “structure.” The instruction 32 includes a symbol 32a to instruct an insertion of the character string. Especially, in this example, it is desired that the preceding and succeeding character strings of the character string “of” are inverted (Structure of Document) due to the insertion of the character string “of.”

The instruction 33 is an instruction to delete three characters “BBB.” The instruction 33 is constituted of a symbol 33a to instruct a deletion of the characters.

The instruction 34 is an instruction to exchange a row of “CCC” and a row of “DDDDD.” The instruction 34 is constituted of a symbol 34a to instruct an exchange of the rows.

The instruction 35 is an instruction to add a character string “ttttt” between a character string “FFF” and a character string “FFFFF.” The instruction 35 includes a symbol 35a to instruct an insertion of the character string.

The instruction 36 is an instruction to delete a drawing. The instruction 36 is constituted of a symbol 36a to instruct a deletion of the drawing.

The instruction 37 is an instruction to move a drawing. The instruction 37 is constituted of a symbol 37a to instruct a move of the drawing.

The instruction 38 is an instruction to delete a character string “Drawing 3-2.” The instruction 38 is constituted of a symbol 38a to instruct a deletion of the character string.

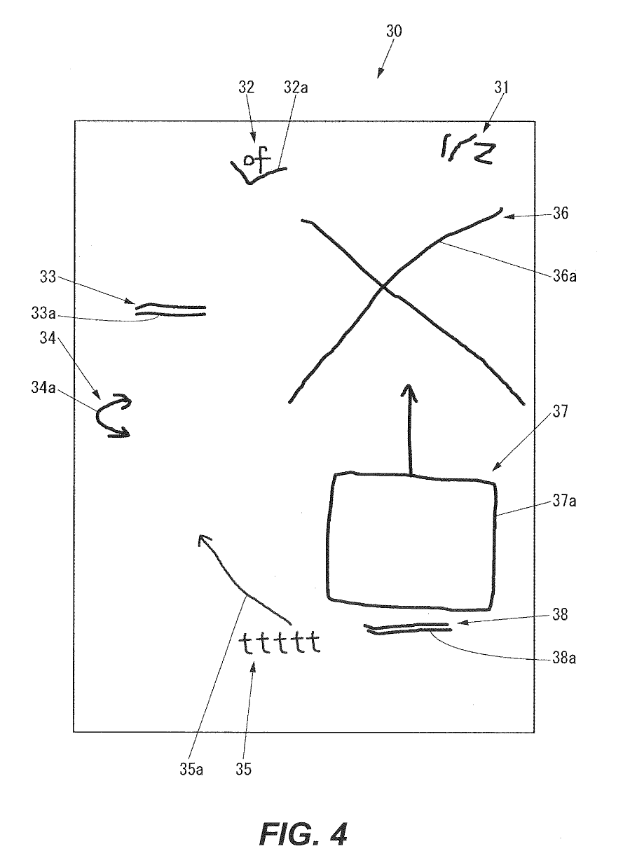

As illustrated in FIG. 2, the revised-portion extracting unit 18b extracts an image 30 (for example, see FIG. 4) of the revised portion from the image 20 read at Step S101 based on the specific color after the process at Step S101 (Step S102).

FIG. 4 illustrates the image 30 of the revised portion of the revised and corrected original document illustrated in FIG. 3.

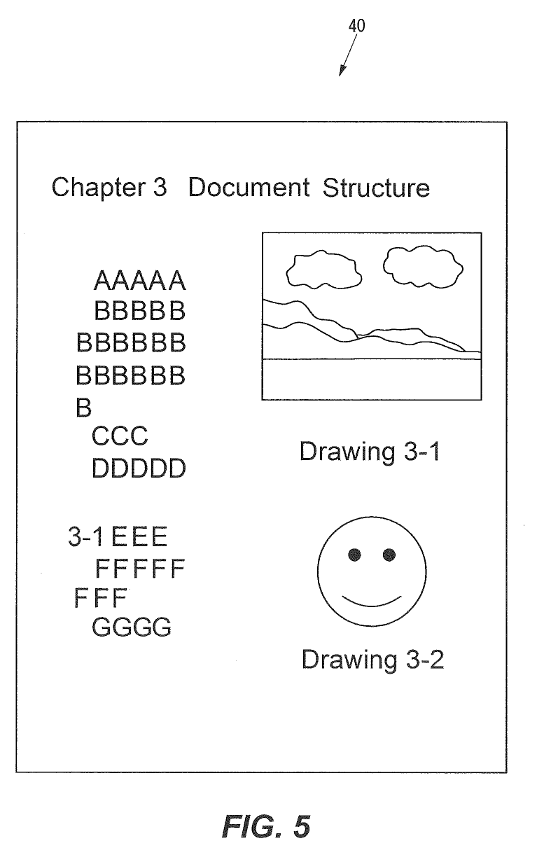

As illustrated in FIG. 2, the initial original document reproducing unit 18c reproduces the image 40 (for example, see FIG. 5) of the initial original document by removing the image 30 extracted at Step S102 from the image 20 read at Step S101 after the process at Step S102 (Step S103). Here, the initial original document reproducing unit 18c is configured to reproduce colors of the initial original document based on a change in colors of the revised portion caused by the color of the revised portion overlapping the colors of the initial original document and complement the colors of the initial original document from peripheral colors, that is, colors of a portion of the image 40 of the initial original document where the image 30 of the revised portion does not overlap for a portion of the image 20 where the image 30 of the revised portion overlaps the image 40 of the initial original document.

FIG. 5 illustrates the image 40 of the initial original document of the revised and corrected original document illustrated in FIG. 3.

As illustrated in FIG. 2, the region extracting unit 18d extracts the region of the character or the drawing from the image 40 of the initial original document reproduced at Step S103 after the process at Step S103 (Step S104). Here, the region extracting unit 18d extracts the region of the character from the image 40 when the image 40 has a character. The region extracting unit 18d extracts the region of the drawing per drawing from the image 40 when the image 40 has a drawing. The region extracting unit 18d is configured to extract a plurality of character regions from, for example, a change in distance between characters in the image 40 and an arrangement of a drawing region when the character region is extracted.

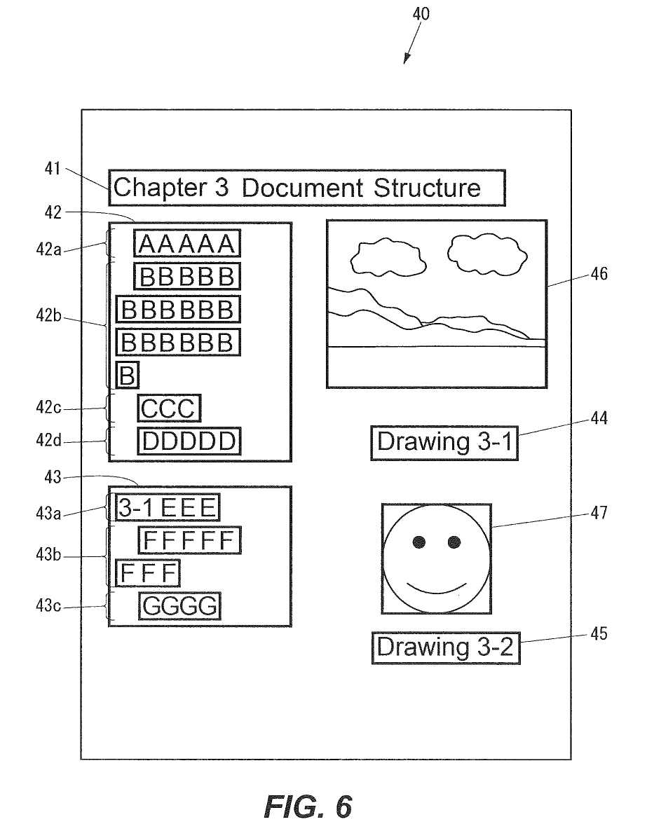

FIG. 6 illustrates the image 40 of the initial original document separated into a plurality of regions.

The image 40 illustrated in FIG. 6 is separated into character regions 41 to 45 and drawing regions 46 and 47. Here, the region 42 includes paragraphs 42a, 42b, 42c, and 42d. The region 43 includes a title 43a and paragraphs 43b and 43c.

As illustrated in FIG. 2, the layout index determining unit 18e determines whether the character region exists or not after the process at Step S104 (Step S105).

The layout index determining unit 18e detects the character by Optical Character Recognition (OCR) for each character region upon determining that the character region exists at Step S105 (Step S106).

After determining that the character region does not exist at Step S105 or the termination of the process at Step S106 (Step S107), the layout index determining unit 18e determines whether all the pages of the revised and corrected original document have been processed or not.

When it is determined that not all the pages of the revised and corrected original document have been processed, in other words, there are pages that has not been yet processed and left in the revised and corrected original document at Step S107, the control unit 18 executes the processes from Step S101 to S106 for the subsequent pages.

When the layout index determining unit 18e determines that all the pages of the revised and corrected original document have been processed at Step S107 (Step S108), the layout index determining unit 18e generates original document layout information that indicates respective layouts of the character region and the drawing region extracted at Step S104 for each of all the pages of the initial original document of the revised and corrected original document.

For example, the layout index determining unit 18e determines a continuity between the character regions included in an identical page of the initial original document and a continuity between the character regions included between the neighboring pages of the initial original document, and includes the determination result in the original document layout information.

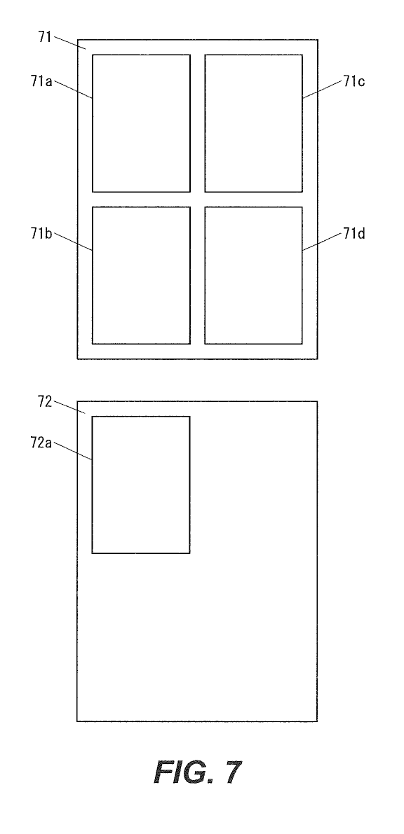

The layout index determining unit 18e determines a continuity between the regions neighboring in a vertical direction, such as between regions 71a and 71b and regions 71c and 71d, as a continuity between the character regions included in an identical page 71 as illustrated in, for example, FIG. 7. When the layout of the initial original document is a layout having a double column setting or more, the layout index determining unit 18e determines a continuity between the lowest region and the highest region in a column on an immediate right of a column where the lowest region belongs, such as the regions 71b and 71c illustrated in FIG. 7, as a continuity between the character regions included in the identical page.

The layout index determining unit 18e determines a continuity between neighboring two pages of a lower right region in the preceding page and an upper left region in the succeeding page, such as the region 71d as the last region in the page 71 and a region 72a as the first region in a page 72, which is a subsequent page of the page 71, as illustrated in FIG. 7, as a continuity between the character regions included in the neighboring pages of the initial original document.

The layout index determining unit 18e is configured to determine a continuity between the plurality of regions using the characters detected at Step S106. That is, the layout index determining unit 18e is configured to determine the continuity between the regions based on a continuity in character contents between the plurality of regions. For example, the layout index determining unit 18e is configured to determine that there is the continuity in character contents between these regions when one word, one phrase, one clause, or one sentence can be determined to cross over two regions. As a result, the layout index determining unit 18e can determine that there is the continuity between these regions.

The layout index determining unit 18e is configured to determine a continuity between the regions based on a continuity in paragraph formats between the plurality of regions. For example, when a word that exists at the last column in the last row in a target region is not a terminating character or a blank character in an ordinary sentence, such as a period, and a word that exists at the first column in the first row in a subsequent region to the target region is not a starting character in the a ordinary sentence, such as a blank character, the layout index determining unit 18e may determine that there is a continuity in the character contents between these regions. When the first column in the first row in the target region is not indented, the layout index determining unit 18e may also determine that there is a continuity in the character contents between this region and the region before this region.

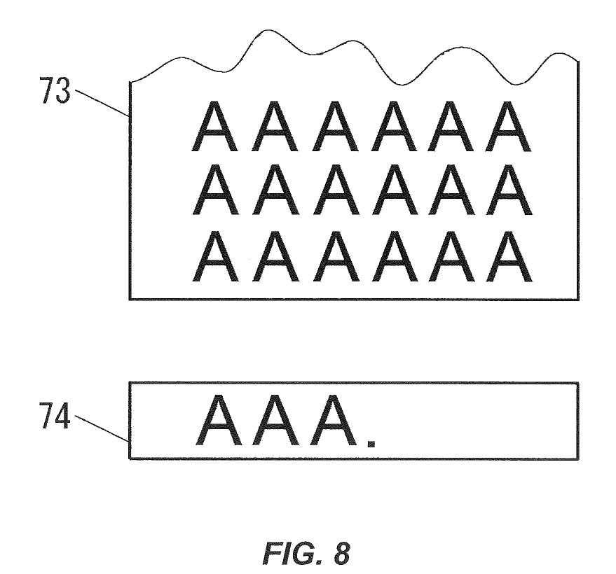

The layout index determining unit 18e obtains a start position (a left end position), a center position, and an end position (a right end position) in a lateral direction of the image 40 of the initial original document and a start position (an upper end position) and an end position (a lower end position) in a vertical direction of the image 40 of the initial original document for each of the regions. Then, when there are regions where these obtained positions match one another, the layout index determining unit 18e determines adjusting these regions to match these positions one another as a layout. This is because when these positions match, it is highly possible that the position is thus arranged on purpose. The layout index determining unit 18e unifies and captures a width in the lateral direction between the regions that are determined to have the continuity regardless of a width of a character string that is actually included in the region. For example, in an example illustrated in FIG. 8, a region 74 has been determined that there has been a continuity with a region 73 that has a width of six characters in one row. The layout index determining unit 18e unifies the region 74 with the region 73 and captures the region 74 as a region having the width of six characters in one row even though the region 74 actually has only four characters of “AAA.” in one row.

The layout index determining unit 18e obtains a distance between the regions. Then, the layout index determining unit 18e determines that the distance between these regions is to be maintained as a layout when the obtained distance between these is at a certain distance or less, such as a distance for two rows.

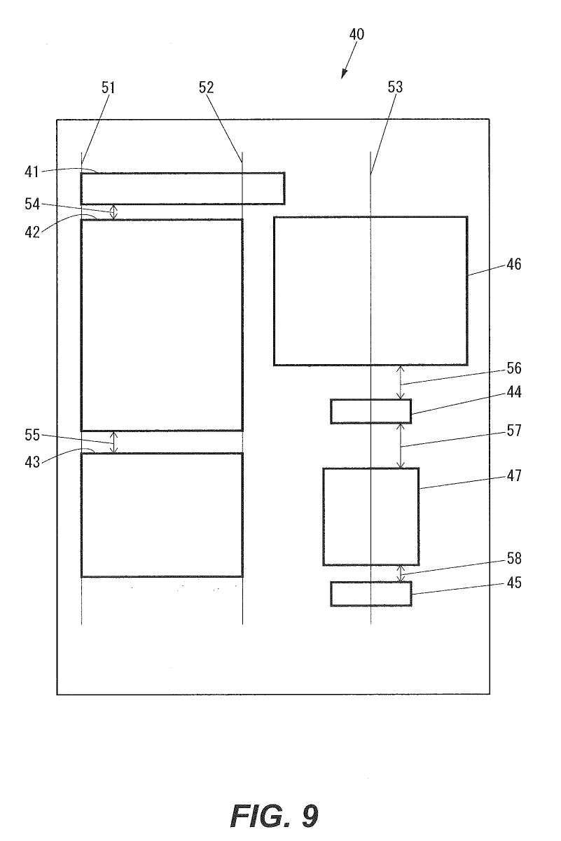

FIG. 9 illustrates the original document layout information generated from the image 40.

For example, the layout index determining unit 18e determines that the regions 41 to 43 have the matched start positions in the lateral direction as a line segment 51 in FIG. 9 illustrates. The layout index determining unit 18e determines that the regions 42 and 43 have the matched end positions in the lateral direction as a line segment 52 in FIG. 9 illustrates. The layout index determining unit 18e determines that the regions 44 to 47 have the matched center positions in the lateral direction as a line segment 53 in FIG. 9 illustrates. The layout index determining unit 18e determines that, for example, a distance 54 between the regions 41 and 42, a distance 55 between the regions 42 and 43, a distance 56 between the regions 44 and 46, a distance 57 between the regions 44 and 47, and a distance 58 between the regions 45 and 47 are each maintained.

As illustrated in FIG. 2, the original document editing unit 18f executes an editing process of the image 40 of the initial original document according to an instruction content of the revised portion extracted at Step S102 after the process at Step S108 (Step S109), and terminates the operation illustrated in FIG. 2.

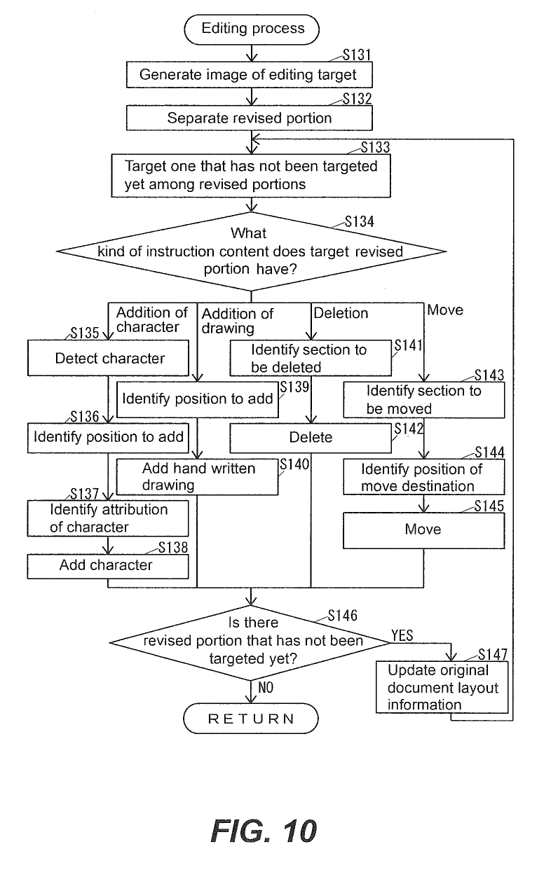

FIG. 10 illustrates the editing process at Step S109.

As illustrated in FIG. 10, the original document editing unit 18f generates an image of an editing target by copying the image 40 of the initial original document (Step S131).

Next, the original document editing unit 18f separates the revised portion according to the distance between each and the content of each based on the image 20 read at Step S101 and the image 30 of the revised portion extracted at Step S102 (Step S132). For example, the original document editing unit 18f separates the revised portion included in the image 30 into the instructions 31 to 38 in the example illustrated in FIG. 4.

The original document editing unit 18f targets one that has not been targeted yet among the revised portions that are separated at Step S132 after the process at Step S132 (Step S133).

Next, the original document editing unit 18f determines a kind of the instruction content of the currently targeted revised portion (Step S134).

The original document editing unit 18f recognizes the character string of the currently targeted revised portion by OCR upon determining that the instruction content is “addition of character string,” such as the instructions 31, 32, and 35, at Step S134 (Step S135).

Next, the original document editing unit 18f identifies a position to which the character string of the currently targeted revised portion is added (Step S136).

Specifically, when the position to which the character string of the currently targeted revised portion is added is specifically designated in the character region that is specified in the specific layout information 17b and the original document layout information at Step S136, the original document editing unit 18f identifies the position.

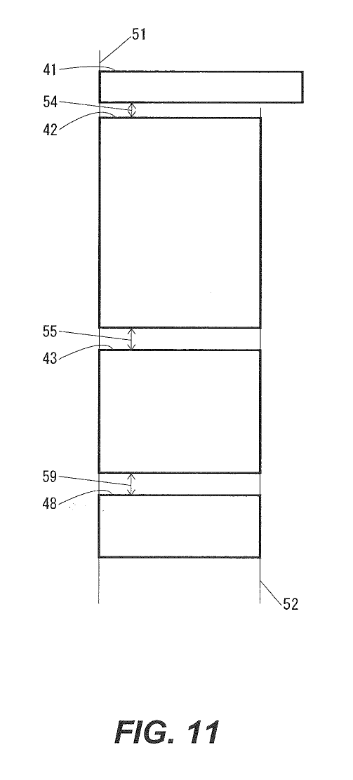

The original document editing unit 18f identifies a layout in a new region based on the specific layout information 17b and the original document layout information, and a position of the currently targeted revised portion in the revised and corrected original document when the position to which the character string of the currently targeted revised portion is added is not specifically designated in the character region that is specified in the specific layout information 17b and the original document layout information at Step S136. For example, when other regions are arranged aligning at the start positions in the lateral direction of the image of the editing target, the original document editing unit 18f arranges the start position of the currently targeted revised portion so as to align with the other regions when the start position of the currently targeted revised portion is arranged near these start positions. While the description has been made for the start position of the region in the lateral direction in the editing target image, the same applies to the center position and the end position in the region in the lateral direction in the editing target image and the start position and the end position in the region in the vertical direction in the editing target image. The original document editing unit 18f may align a distance between the region of the currently targeted revised portion and a region next to the region of the currently targeted revised portion to a distance between the nearby regions. The original document editing unit 18f may specify a hand written position of the currently targeted revised portion as a position to which the currently targeted revised portion is added, for example, when there is no regularity in the start position, the center position, and the end position of the region in the lateral direction in the editing target image and the start position and the end position of the region in the vertical direction of the editing target image for the currently targeted revised portion. For example, when a character region 48 is newly added below the region 43 as illustrated in FIG. 11, the original document editing unit 18f specifies the start position and the end position of the region 48 in the lateral direction with the respective line segments 51 and 52, and aligns a distance 59 between the region 43 and the region 48 with the distance 55 between the region 42 and the region 43.

The original document editing unit 18f identifies an attribution of the character of the currently targeted revised portion after the process at Step S136 (Step S137). For example, when there is a region to which the character of the currently targeted revised portion is added, the original document editing unit 18f obtains the attributions of characters in the periphery of the position to which the character of the currently targeted revised portion is added in the region to which the character of the currently targeted revised portion is added. The original document editing unit 18f identifies the obtained attribution as the attribution of the character of the currently targeted revised portion.

The original document editing unit 18f adds the character detected at Step S135 to the position identified at Step S136 with the attribution identified at Step S137 or the attribution indicated with the character attribution information 17c for the editing target image after the process at Step S137 (Step S138).

For example, when the position to which the character of the currently targeted revised portion is added is a position at a midpoint in the region, such as a position between specific rows in the character region specified by the specific layout information 17b and the original document layout information, the original document editing unit 18f shifts a portion behind the character of the currently targeted revised portion backward by an amount of the added character of the currently targeted revised portion by adding the character of the currently targeted revised portion at this position. When the character is added in a paragraph in the region, the original document editing unit 18f maintains the paragraph after shifting when the portion behind the added portion is shifted backward. Here, the original document editing unit 18f determines an indented row in the region as a starting row of the paragraph. The original document editing unit 18f determines a row with a blank from the middle to the end, a row immediate before a starting row of a subsequent paragraph, and the last row in the region as an end row of the paragraph. By adding the character of the currently targeted revised portion, the original document editing unit 18f shifts a portion behind the region including this character backward as necessary by an amount of an increased size of this region. However, when the distance between the regions is larger than a certain distance, such as a distance for two rows, the original document editing unit 18f does not shift the latter region among these regions backward behind the region including the character to be added until the distance between the regions becomes the certain distance.

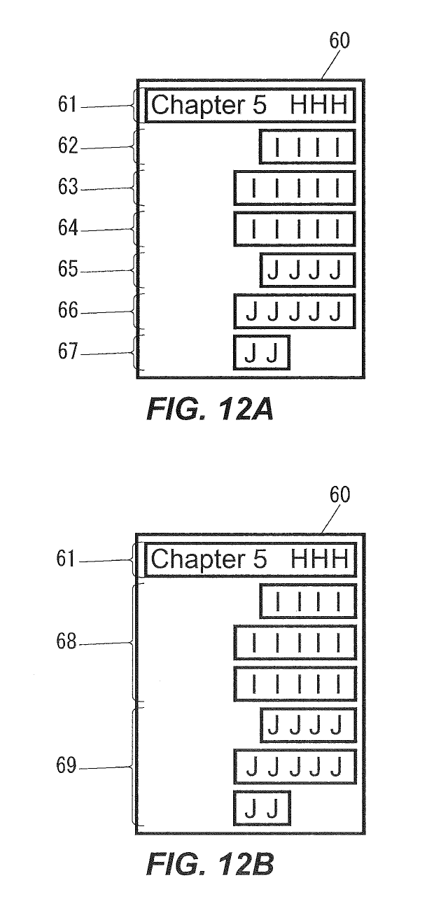

The original document editing unit 18f is configured to detect a row of a “title” in the character region by detecting a certain format, such as chapter “ . . . chapter . . . ,” and detecting a change in the character size by the character detection at Step S106. Accordingly, when a subsequent paragraph itself to the “title” is indented in the region, the original document editing unit 18f is configured to prevent all the rows subsequent to the “title” in this region from each being incorrectly detected as a paragraph. For example, as illustrated in FIG. 12A, when a row 61 is not detected as a “title” in a region 60, the original document editing unit 18f detects all the subsequent rows as each paragraph. That is, the original document editing unit 18f incorrectly detects that there are paragraphs 62 to 67 as illustrated in FIG. 12A. On the other hand, as illustrated in FIG. 12B, when the row 61 is detected as the “title” in the region 60, the original document editing unit 18f accurately detects paragraphs 68 and 69.

The original document editing unit 18f identifies a position to which a hand written drawing in the currently targeted revised portion is added upon determining that the instruction content is “addition of drawing” at S134 (Step S139).

Specifically, the original document editing unit 18f identifies a layout of a new region based on the specific layout information 17b and the original document layout information, and a position of the currently targeted revised portion in the revised and corrected original document at Step S139. For example, when other regions are arranged aligning at the start positions in the lateral direction of the image of the editing target, the original document editing unit 18f arranges the start position of the currently targeted revised portion so as to align with the other regions when the start position of the currently targeted revised portion is arranged near these start positions. While the description has been made for the start position of the region in the lateral direction in the editing target image, the same applies to the center position and the end position in the region in the lateral direction in the editing target image and the start position and the end position in the region in the vertical direction in the editing target image. The original document editing unit 18f may align a distance between the region of the currently targeted revised portion and a region next to the region of the currently targeted revised portion to a distance between the nearby regions. The original document editing unit 18f may specify a hand written position of the currently targeted revised portion as a position to which the currently targeted revised portion is added, for example, when there is no regularity in the start position, the center position, and the end position of the region in the lateral direction in the editing target image and the start position and the end position of the region in the vertical direction of the editing target image for the currently targeted revised portion.

The original document editing unit 18f adds the hand written drawing in the currently targeted revised portion to the position specified at Step S139 for the editing target image after the process at Step S139 (Step S140).

For example, by adding the hand written drawing in the currently targeted revised portion, the original document editing unit 18f shifts a portion behind the region where this drawing is added backward as necessary by an amount of this region being added.

The original document editing unit 18f identifies a section that is designated to be deleted in the currently targeted revised portion upon determining that the instruction content is “deletion,” such as the instructions 33, 36, and 38, at Step S134 (Step S141).

Next, the original document editing unit 18f deletes the section identified at Step S141 for the editing target image (Step S142).

For example, when the middle portion in the region is deleted, the original document editing unit 18f shifts a portion behind the deletion portion forward by an amount of deletion of the deletion portion in this region. When the character is deleted from a paragraph in the region, the original document editing unit 18f maintains the paragraph after shifting when the portion behind the deletion portion is shifted forward. Here, since the original document editing unit 18f is configured to detect the row of the “title” in the character region, when a subsequent paragraph itself to the “title” is indented in the region, the original document editing unit 18f is configured to prevent all the rows subsequent to the “title” in this region from each being incorrectly detected as a paragraph. By deleting a specific part, the original document editing unit 18f shifts a portion behind the region including this part forward as necessary by an amount of a decreased size of this region.

The original document editing unit 18f identifies a section designated to be moved in the currently targeted revised portion upon determining that the instruction content is “move,” such as the instructions 34 and 37, at Step S134 (Step S143).

Next, the original document editing unit 18f identifies a position of a move destination designated with the currently targeted revised portion (Step S144).

Next, the original document editing unit 18f moves the section identified at Step S143 to the position identified at Step S144 for the editing target image (Step S145).

For example, the original document editing unit 18f, when adding the section identified at Step S143 to the move destination, shifts a portion behind a portion to which this section is added backward as necessary by an amount of this section being added. However, when the distance between the regions is larger than a certain distance, such as a distance for two rows, the original document editing unit 18f does not shift the latter region of these regions backward behind the region including the character to be added when the character is added until the distance between the regions becomes the certain distance. The original document editing unit 18f, when deleting the section identified at Step S143 in an original position of move, shifts a portion behind a portion from which this section is deleted forward as necessary by an amount of this section being deleted. When the character is added to a paragraph in the region, the original document editing unit 18f maintains the paragraph after shifting when a portion behind the added portion is shifted backward. When the character is deleted from a paragraph in the region, the original document editing unit 18f maintains the paragraph after shifting when a portion behind the deletion portion is shifted forward. Here, since the original document editing unit 18f is configured to detect the row of the “title” in the character region, when a subsequent paragraph itself to the “title” is indented in the region, the original document editing unit 18f is configured to prevent all the rows subsequent to the “title” in this region from each being incorrectly detected as a paragraph.

The original document editing unit 18f determines whether there is any that has not been targeted yet or not among the revised portions separated at Step S132 after the processes at Steps S138, S140, S142 or S145 (Step S146).

The original document editing unit 18f updates the original document layout information (Step S147), and executes the process at Step S133 upon determining at Step S146 that there is one that has not been targeted yet among the revised portion separated at Step S132.

The original document editing unit 18f terminates the operation illustrated in FIG. 10 upon determining at Step S146 that there is none that has not been targeted yet among the revised portion separated at Step S132.

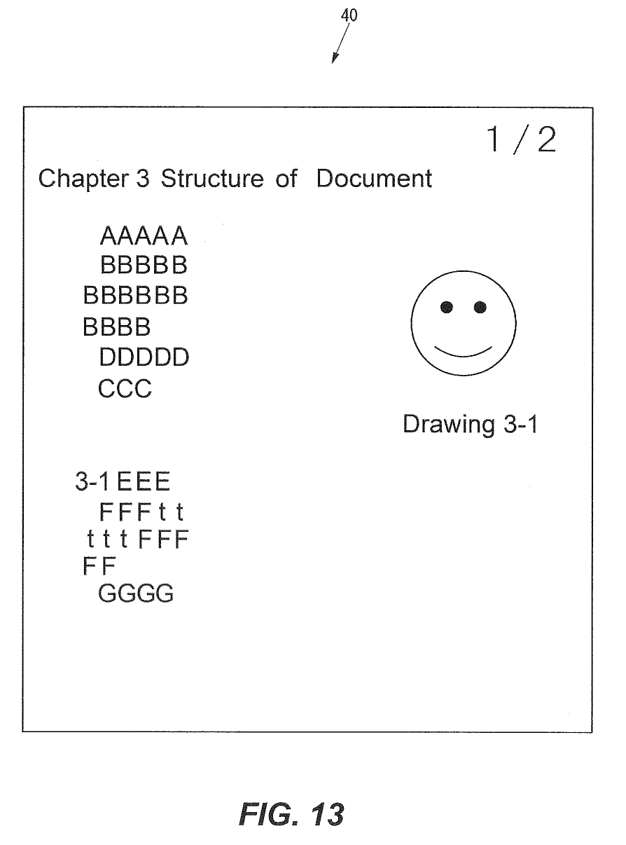

For example, the MFP 10 eventually generates a document illustrated in FIG. 13 as the editing target image by executing the operation illustrated in FIG. 2 when the document is digitized based on the revised and corrected original document illustrated in FIG. 3. Accordingly, the MFP 10 can print the document illustrated in FIG. 13 with the printer 14 and store the document in the storage unit 17.

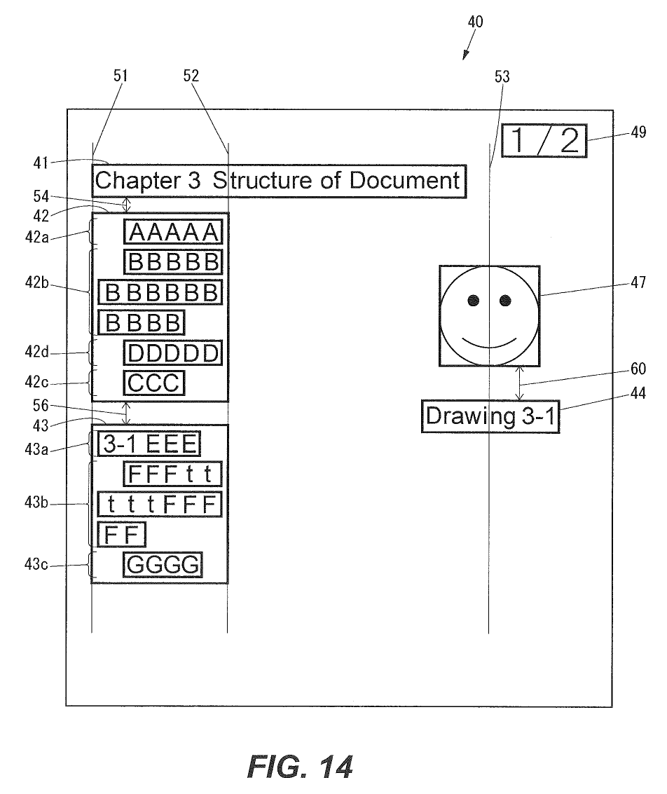

The document illustrated in FIG. 13 has a layout as illustrated in FIG. 14. The image illustrated in FIG. 14, in comparison with the image 40 of the initial original document illustrated in FIG. 6, is corrected as follows.

The region 41 has an added “of” according to the instruction 32. The region 41 has the start position in the lateral direction and the start position and the end position in the vertical direction not changed.

The region 42 has deleted three characters “BBB” according to the instruction 33. The region 42 has a row “CCC” and a row “DDDDD” exchanged according to the instruction 34. The region 42 has the start position and the end position in the lateral direction and the start position in the vertical direction not changed. The region 42 has the end position in the vertical direction raised by the reduced one row.

The region 43 has the added character string “ttttt” according to the instruction 35. The region 43 has the start position and the end position in the lateral direction and the end position in the vertical direction not changed. The region 43 has the start position in the vertical direction raised by the reduced one row of the region 42.

The region 45 is deleted according to the instruction 38.

The region 46 is deleted according to the instruction 36.

The region 47 is moved according to the instruction 37. The region 47 has the center position in the lateral direction not changed. The region 47 has a distance 60 between the end position in the vertical direction and the start position of the region 44 in the vertical direction equal to the distance 56 (see FIG. 9) between the region 44 and the region 46 in the image 40 of the initial original document.

A region 49 has the added character string “1/2” in the header according to the instruction 31. The original document editing unit 18f sets the layout within the header according to the specific layout information 17b.

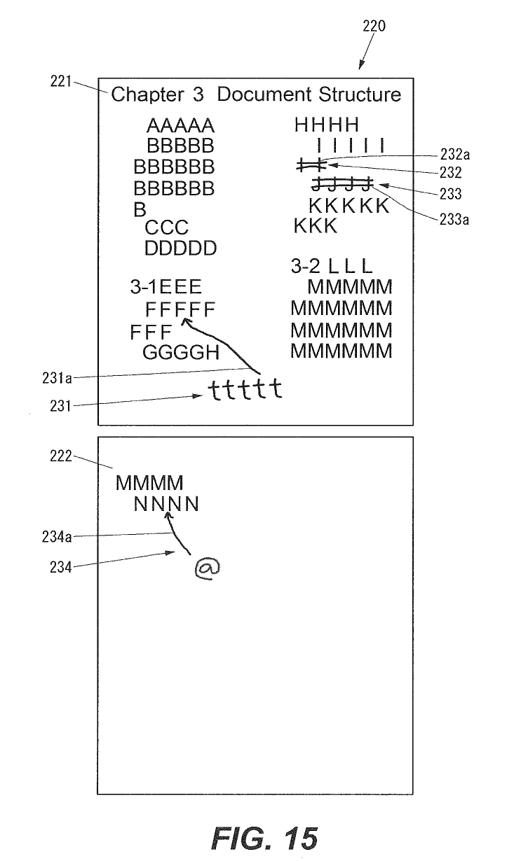

FIG. 15 illustrates an example of an image 220 of a revised and corrected original document.

The image 220 illustrated in FIG. 15 is constituted of an image 221 of an original document on a first page and an image 222 of an original document on a second page. The image is an image 240 of an initial original document with added correction instructions 231 to 234 by hand writing with a writing material in a certain color, such as red.

The instruction 231 is an instruction to add a character string “ttttt” between a character string “FFF” and a character string “FFFFF.” The instruction 231 includes a symbol 231a to instruct an insertion of the character string.

The instruction 232 is an instruction to delete two characters “II.” The instruction 232 is constituted of a symbol 232a to instruct a deletion of the characters.

The instruction 233 is an instruction to delete four characters “JJJJ.” The instruction 233 is constituted of a symbol 233a to instruct a deletion of the characters.

The instruction 234 is an instruction to add a character string “@” between a character string “NN” and a character string “NN.” The instruction 234 includes a symbol 234a to instruct an insertion of the character string.

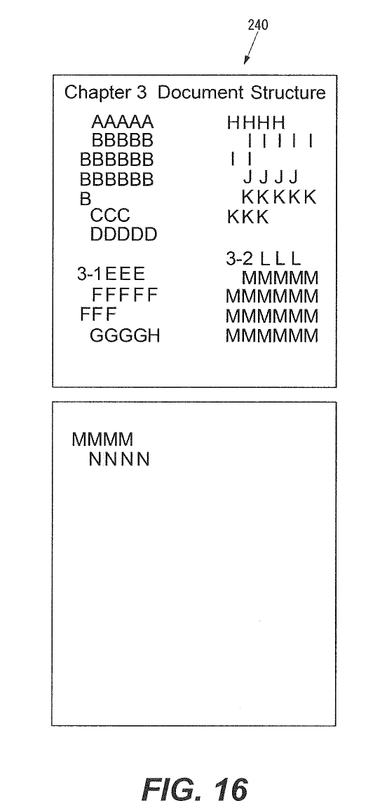

FIG. 16 illustrates the image 240 of the initial original document of the revised and corrected original document illustrated in FIG. 15.

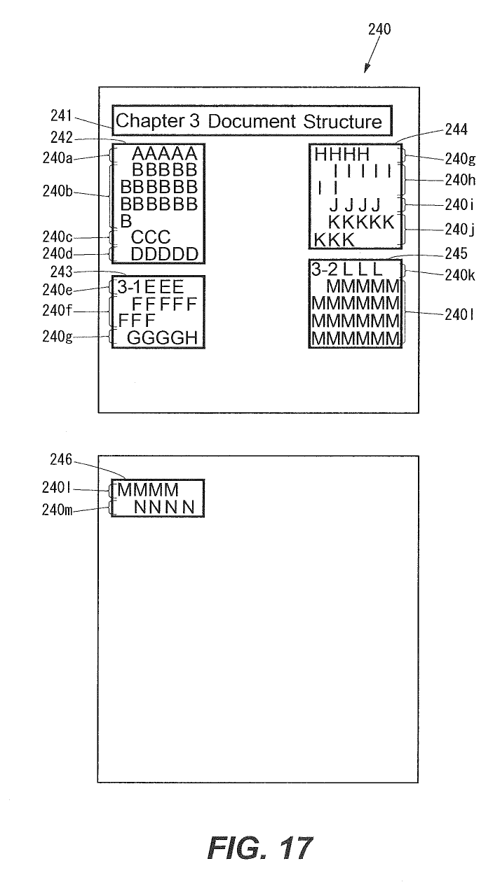

FIG. 17 illustrates the image 240 of the initial original document separated into a plurality of regions.

The image 240 illustrated in FIG. 17 is separated into character regions 241 to 246. Here, the region 242 includes paragraphs 240a, 240b, 240c, and 240d. The region 243 includes a title 240e, a paragraph 240f, and a part of a paragraph 240g. The region 244 includes a part of the paragraph 240g, and paragraphs 240h, 240i, and 240j. The region 245 includes a title 240k and a part of a paragraph 240l. The region 246 includes a part of the paragraph 240l and a paragraph 240m.

The layout index determining unit 18e determines that there is a continuity between the region 243 and the region 244 at Step S108 based on a continuity of character contents between the region 243 and the region 244 and a continuity of paragraph formats between the region 243 and the region 244. Similarly, the layout index determining unit 18e determines that there is a continuity between the region 245 and the region 246 at Step S108 based on a continuity of character contents between the region 245 and the region 246 and a continuity of paragraph formats between the region 245 and the region 246.

The region 246 has been determined that there has been a continuity with the region 245 that has a width of six characters in one row. At Step S108, the layout index determining unit 18e unifies the region 246 with the region 245 and captures the region 246 as a region having the width of six characters in one row even though the region 246 actually has only five characters including a blank “NNNN” maximum in one row.

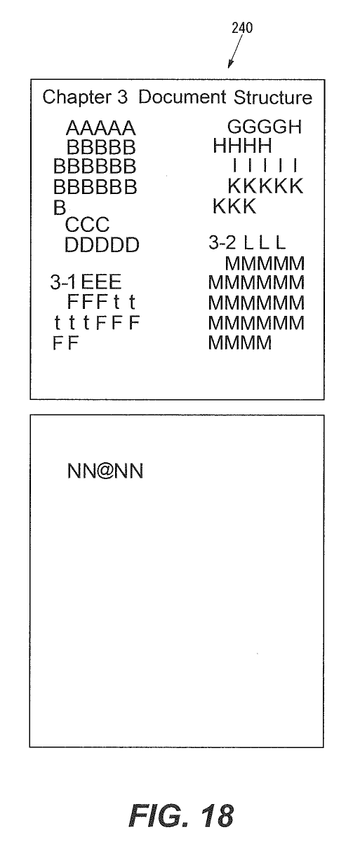

For example, the MFP 10 eventually generates document illustrated in FIG. 18 as an editing target image by executing the operation illustrated in FIG. 2 when the document is digitized based on the revised and corrected original document illustrated in FIG. 15. Accordingly, the MFP 10 can print the document illustrated in FIG. 18 with the printer 14 and store the document in the storage unit 17.

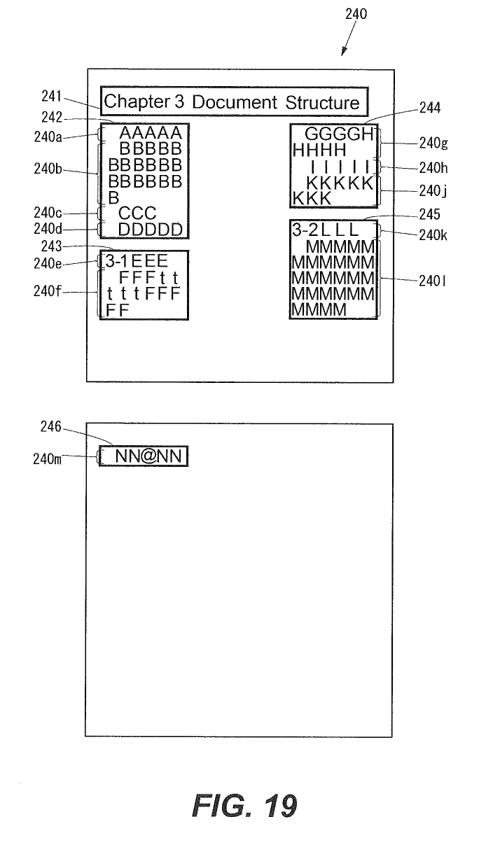

The document illustrated in FIG. 18 has a layout as illustrated in FIG. 19. The image illustrated in FIG. 19, in comparison with the image 240 of the initial original document illustrated in FIG. 17, is corrected as follows.

The regions 241 and 242 have no change.

The regions 243 and 244 have the added characters “ttttt” according to the instruction 231. The regions 243 and 244 have the deleted characters “II” according to the instruction 232 and the deleted characters “JJJJ” according to the instruction 233. The region 243 has the start position and the end position in the lateral direction and the start position and the end position in the vertical direction not changed. The region 244 has the end position in the vertical direction raised by one row with the paragraph 240f having one row increased, the paragraph 240h having one row decreased, and the paragraph 240i of one row being deleted in a consecutive region constituted of the region 243 and the region 244.

The region 245 has the start position in the vertical direction raised by one row since the end position of the region 244 in the vertical direction is raised by one row. However, by including the entire paragraph 240l included in a consecutive region constituted of the region 245 and the region 246, the region 245 has a width in the vertical direction increased by one row, therefore the end position in the vertical direction does not change. The region 245 has the start position and the end position in the lateral direction not changed.

By the region 245 including the entire paragraph 240l included in the consecutive region constituted of the region 245 and the region 246, the region 246 has a width in the vertical direction decreased by one row, therefore the end position in the vertical direction is raised by one row. The region 246 has the start position in the vertical direction and the start position and the end position in the lateral direction not changed.

As described above, when generating the digitized document by editing the initial original document with the correction content that is instructed by the revised portion extracted from the image of the revised and corrected original document, the MFP 10 determines the continuity between character regions among the regions included in the initial original document of the revised and corrected original document and edits the initial original document as the continued plurality of regions that are determined to have the continuity, thereby ensuring an improved appropriateness of layout in the digitized document based on the revised and corrected original document.

Since the MFP 10 determines the continuity between the regions based on the continuity of the character contents between the plurality of regions, thereby ensuring an improved appropriateness in determining the continuity between the regions. Accordingly, the MFP 10 can improve the appropriateness of layout in the digitized document based on the revised and corrected original document.

Since the MFP 10 determines the continuity between the regions based on the continuity of the paragraph formats between the plurality of regions, thereby ensuring an improved appropriateness in determining the continuity between the regions. Accordingly, the MFP 10 can improve the appropriateness of layout in the digitized document based on the revised and corrected original document.

The MFP 10 may determine that there is a continuity between the regions only when both the continuity of the character contents and the continuity of the paragraph formats are fulfilled between the plurality of regions.

Even when the initial original document itself is not available, the MFP 10 is configured to reproduce the initial original document as long as the revised and corrected original document is available, therefore a convenience can be improved. The MFP 10 may store the image of the initial original document in the storage unit 17 and use the image of the initial original document stored in the storage unit 17 without reproducing the initial original document from the revised and corrected original document.

A part of a method for digitizing the document of the disclosure may be achieved not with the MFP 10, but with a computer, such as a Personal Computer (PC).

While the image forming apparatus of the disclosure is the MFP according to the embodiment, the image forming apparatus of the disclosure may be an image forming apparatus other than the MFP.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image forming apparatus comprising:
a reading device that reads an image from an original document;
a Central processing unit (CPU); and
a storage device that includes a document digitizing program, the CPU executing the document digitizing program to function as:
an image obtaining unit that obtains an image of a revised and corrected original document corrected by hand writing using the reading device;
a revised-portion extracting unit that extracts a revised portion from the image of the revised and corrected original document obtained by the image obtaining unit;
a region extracting unit that extracts a region included in an initial original document of the revised and corrected original document from the initial original document;
a layout index determining unit that determines an index of a layout of the initial original document based on the region extracted by the region extracting unit; and
an original document editing unit that edits the initial original document with a correction content instructed with the revised portion extracted by the revised-portion extracting unit according to the index determined by the layout index determining unit, so as to generate a digitized document,
wherein the layout index determining unit determines a continuity between the regions of characters, and
the original document editing unit edits the initial original document as a continued plurality of the regions that are determined to have a continuity by the layout index determining unit.

2. The image forming apparatus according to claim 1,
wherein the layout index determining unit determines a continuity between the regions based on a continuity of character contents between the plurality of regions.

3. The image forming apparatus according to claim 1,
wherein the layout index determining unit determines a continuity between the regions based on a continuity of paragraph formats between the plurality of regions.

4. The image forming apparatus according to claim 1,
wherein the CPU executes the document digitizing program to further function as an initial original document reproducing unit that reproduces the initial original document from the image of the revised and corrected original document,
the revised-portion extracting unit extracts the revised portion from the image of the revised and corrected original document based on a color, and
the initial original document reproducing unit removes the revised portion extracted by the revised-portion extracting unit from the image of the revised and corrected original document to reproduce the initial original document.

5. A non-transitory computer-readable recording medium that stores a document digitizing program for controlling an image forming apparatus including a reading device that reads an image from an original document, the document digitizing program causing the image forming apparatus to function as:
an image obtaining unit that obtains an image of a revised and corrected original document corrected by hand writing using the reading device;
a revised-portion extracting unit that extracts a revised portion from the image of the revised and corrected original document obtained by the image obtaining unit
a region extracting unit that extracts a region included in an initial original document of the revised and corrected original document from the initial original document;
a layout index determining unit that determines an index of a layout of the initial original document based on the region extracted by the region extracting unit; and
an original document editing unit that edits the initial original document with a correction content instructed with the revised portion extracted by the revised-portion extracting unit according to the index determined by the layout index determining unit, so as to generate a digitized document,
wherein the layout index determining unit determines a continuity between the regions of characters, and
the original document editing unit edits the initial original document as a continued plurality of the regions that are determined to have a continuity by the layout index determining unit.

6. A method for digitizing a document, the method comprising:
obtaining an image of a revised and corrected original document corrected by hand writing using a reading device;
extracting a revised portion from the image of the revised and corrected original document;
extracting a region included in an initial original document of the revised and corrected original document from the initial original document;
determining an index of a layout of the initial original document based on the extracted region; and
editing the initial original document with a correction content instructed with the revised portion extracted by the extracting the region according to the index determined by the determining, so as to generate a digitized document,
wherein the index of the layout of the initial original document is determined based on a continuity between the regions of characters, and
the initial original document is edited as a continued plurality of the regions that are determined to have the continuity.
